(19) United States
(12) Patent Application Publication
(10) Pub. No.: US 2025/0317029 A1
(43) Pub. Date: Oct. 9, 2025

(54) Systems and Methods for Using Auxiliary Windings of an Electric Motor for Powering Electronic Components

(71) Applicant: ABB Schweiz AG, Baden (CH)

(72) Inventors: Graham L. Medlin, Durham, NC (US); Rajib Mikail, Raleigh, NC (US); Utkarsh Raheja, Sunnyvale, CA (US); Alex M. Danci, Tolby (FI); Jouni Ikaheimo, Kurikka (FI)

(73) Assignee: ABB Schweiz AG, Baden (CH)

(21) Appl. No.: 18/863,044

(22) PCT Filed: May 11, 2022
(86) PCT No.: PCT/IB2022/054404

§ 371 Date: Nov. 5, 2024

(51) Int. Cl. H02K 11/00; H02K 3/34; H02K 5/22; H02K 11/049; H02K 11/26; H02K 11/33

(52) U.S. Cl. CPC H02K 11/0094; H02K 3/34; H02K 5/225; H02K 11/049; H02K 11/26; H02K 11/33

(57) ABSTRACT

A system comprising a poly-phase electric motor is provided. The poly-phase electric motor comprises a rotor including a motor shaft delineating a rotational axis; a stator concentrically disposed about the rotor, the stator including a stator core and a plurality of stator slots disposed radially into an inner cylindrical stator surface of the stator core; a plurality of primary coils formed from first conductive windings, wherein the plurality of primary coils are located within the plurality of stator slots; an insulating component disposed between the plurality of primary coils and a plurality of auxiliary coils and configured to be an insulation barrier between the plurality of primary coils and a plurality of auxiliary coils; the plurality of auxiliary coils formed from second conductive windings and coupled to the stator; and one or more accessory devices electrically connected to the plurality of auxiliary coils.

### FIELD

The present disclosure relates to motors and, more particularly, to systems and methods for using auxiliary windings of a motor for powering electronic components.

### BACKGROUND

Electric motors are devices that convert electricity into a motive mechanical force output as torque associated with a rotating motor shaft. Electric motors operate on various operating principles and can utilize different types of electrical power. One example is an alternating current electric motor that receives alternating current from a suitable power source. The alternating current is conductively directed through a plurality of conductive windings or coils disposed circumferentially about the stator of the electric motor. Conduction of the alternating current in the windings generate a magnetic field or flux that can electromagnetically interact with the rotor rotatably disposed in and concentrically surrounded by the stator. The periodic or wavelike nature of the alternating current causes the magnetic field produced by the stator windings to concentrically rotate about the stator which the rotor will tend to follow.

In particular, electric motors convert high-voltage electrical power from the electric grid into mechanical power, either directly on-line (DOL) to the electric grid, or through a variable frequency drive (VFD). Motors may be equipped with accessory devices such as automatic greasers, electric heaters, automation equipment, and status indicators. With increased digitalization, more diagnostic sensors are also added into the motor to monitor the operational health. Typically, these sensor and accessory devices require lower voltage to operate and may use a secondary external power supply or a battery to provide the required power. External power supplies are expensive and may be burdensome to install as well as maintain. Stored power in batteries dissipate faster than the motor's useful life. Due to the limitations of built-in batteries, digital capabilities and wireless communication are also limited. Accordingly, there remains a technical need to support sensor and accessory devices during the duration of the motor lifetime.

### SUMMARY

A first aspect of the present disclosure provides a system comprising a poly-phase electric motor. The motor comprises: a rotor including a motor shaft delineating a rotational axis; a stator concentrically disposed about the rotor, the stator including a stator core and a plurality of stator slots disposed radially into an inner cylindrical stator surface of the stator core; a plurality of primary coils formed from first conductive windings, wherein the plurality of primary coils are located within the plurality of stator slots; an insulating component disposed between the plurality of primary coils and a plurality of auxiliary coils and configured to be an insulation barrier between the plurality of primary coils and a plurality of auxiliary coils; the plurality of auxiliary coils formed from second conductive windings and coupled to the stator; and one or more accessory devices electrically connected to the plurality of auxiliary coils, wherein the plurality of primary coils generate a magnetic field based on receiving power from an external power source, wherein the plurality of auxiliary coils harvests energy from the plurality of primary coils and provides the harvested energy to the one or more accessory devices, and wherein the harvested energy comprises an induced current or voltage caused by the generated magnetic field of the plurality of primary coils.

According to an implementation of the first aspect, the poly-phase electric motor further comprises an air gap disposed between the rotor and the stator, and wherein the plurality of auxiliary coils are disposed within the air gap of the poly-phase electric motor.

According to an implementation of the first aspect, a first stator slot, of the plurality of stator slots, comprises: a first subset of primary coils of the plurality of primary coils; and the insulating component, wherein the insulating component is a slot liner and is configured to be the insulation barrier between the plurality of primary coils and the plurality of auxiliary coils within the air gap as well as be an insulation barrier between the rotor and the stator.

According to an implementation of the first aspect, the poly-phase electric motor further comprises a printed circuit board (PCB) comprising the plurality of auxiliary coils, wherein the PCB is coupled to a side of the air gap.

According to an implementation of the first aspect, the plurality of auxiliary coils comprise a number of the turns, and wherein an average area for each of the number of turns follows an inequality of: N*A>0.02, where N is the number of turns and A is the average area in square meters for each of the number of turns.

According to an implementation of the first aspect, the one or more accessory devices comprise one or more sensors and a rectifier, wherein the one or more sensors are solely powered by the harvested energy from the plurality of auxiliary coils.

According to an implementation of the first aspect, the system further comprises: a controller configured to receive sensor information from the one or more sensors; and display information associated with the sensor information.

According to an implementation of the first aspect, the poly-phase electric motor further comprises: a wire terminal box, wherein the wire terminal box comprises: a plurality of first leads configured to provide poly-phase power to the plurality of primary coils; and a user-accessible power port configured to receive the harvested energy from the plurality of auxiliary coils, wherein the system further comprises: an external accessory device electrically connected to the user-accessible power port, wherein the external accessory device is powered solely using the harvested energy from the plurality of auxiliary coils.

According to an implementation of the first aspect, the poly-phase electric motor further comprises: a wire terminal box comprising a plurality of first leads configured to provide poly-phase power to the plurality of primary coils; and an auxiliary terminal box comprising a user-accessible power port configured to receive the harvested energy from the plurality of auxiliary coils, wherein the system further comprises: an external accessory device electrically connected to the user-accessible power port, wherein the external accessory device is powered solely using the harvested energy from the plurality of auxiliary coils.

According to an implementation of the first aspect, the user-accessible power port is a universal serial bus (USB).

According to an implementation of the first aspect, the USB is configured to five volts (V) of direct current (DC) to the external accessory device or an internal accessory device that is within the poly-phase electric motor.

According to an implementation of the first aspect, the user-accessible power port is configured to provide alternating current (AC) to the external accessory device.

According to an implementation of the first aspect, wherein a first stator slot, of the plurality of stator slots, comprises a first subset of primary coils of the plurality of primary coils; and the insulating component, wherein the insulating component is a slot wedge that comprises the plurality of auxiliary coils.

According to an implementation of the first aspect, wherein a first stator slot, of the plurality of stator slots, comprises: a first subset of primary coils of the plurality of primary coils; and the insulating component, wherein the insulating component is a slot liner that comprises the plurality of auxiliary coils.

According to an implementation of the first aspect, wherein a first stator slot, of the plurality of stator slots, comprises: a first subset of primary coils of the plurality of primary coils; and the insulating component, wherein the insulating component is a printed circuit board (PCB) that comprises the plurality of auxiliary coils.

According to an implementation of the first aspect, wherein a first stator slot, of the plurality of stator slots, comprises: a first subset of primary coils of the plurality of primary coils; the insulating component disposed between the plurality of primary coils and the plurality of auxiliary coils; and a second insulating component disposed between the rotor and the stator and configured to be an insulation barrier between the rotor and the stator.

According to an implementation of the first aspect, wherein the poly-phase electric motor further comprises one or more batteries and/or one or more super capacitors.

According to an implementation of the first aspect, wherein the poly-phase electric motor further comprises an internal compartment that houses the one or more accessory devices as well as the one or more batteries and/or the one or more super capacitors.

According to an implementation of the first aspect, wherein the plurality of auxiliary coils are configured to charge and/or re-charge the one or more batteries and/or the one or more super capacitors.

A second aspect of the present disclosure provides a poly-phase electric motor, comprising: a rotor including a motor shaft delineating a rotational axis; a stator concentrically disposed about the rotor, the stator including a stator core and a plurality of stator slots disposed radially into an inner cylindrical stator surface of the stator core; a plurality of primary coils formed from first conductive windings, wherein the plurality of primary coils are located within the plurality of stator slots; an insulating component disposed between the plurality of primary coils and a plurality of auxiliary coils and configured to be an insulation barrier between the plurality of primary coils and a plurality of auxiliary coils; the plurality of auxiliary coils formed from second conductive windings and coupled to the stator; and one or more accessory devices electrically connected to the plurality of auxiliary coils, wherein the plurality of primary coils generate a magnetic field based on receiving power from an external power source, wherein the plurality of auxiliary coils harvests energy from the plurality of primary coils and provides the harvested energy to the one or more accessory devices, and wherein the harvested energy comprises an induced current or voltage caused by the generated magnetic field of the plurality of primary coils.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 is a perspective view of an electric motor delineating a rotational axis and configured for alternating current operation.

FIG. 2 is a schematic illustration of a block diagram depicting an environment for powering motor accessory devices using auxiliary windings of a motor in accordance with the disclosure.

FIG. 3 is a schematic illustration depicting an exemplary environment for powering motor accessory devices using auxiliary windings in accordance with the disclosure.

FIG. 4A is a schematic cross-section representation of an electric motor having a plurality of auxiliary coils and a plurality of stator slots for accommodating a plurality of primary coils in accordance with the disclosure.

FIG. 4B is a detailed view of one section of the electric motor of FIG. 4A that shows the primary coils and the auxiliary coils of the electric motor.

FIGS. 5A-5C are schematic cross-section representations of an electric motor having a plurality of auxiliary coils, a plurality of primary coils, and one or more insulating components in accordance with the disclosure.

FIG. 6A is a schematic illustration depicting stator slots and poles of an electric motor with partial auxiliary windings and full length auxiliary windings in accordance with the disclosure.

FIG. 6B is a schematic illustration depicting an exemplary printed circuit board (PCB) air gap coil in accordance with the disclosure.

FIG. 6C is a captured image of an electrical motor with an exemplary printed circuit board (PCB) air gap coil in accordance with the disclosure.

FIG. 7 is a captured image of an electrical motor with primary and auxiliary windings in accordance with the disclosure.

FIG. 8 is another captured image of an electrical motor with primary and auxiliary windings in accordance with the disclosure.

FIG. 9 depicts an exemplary process for powering motor accessory devices using auxiliary windings of a motor in accordance with the disclosure.

### DETAILED DESCRIPTION

As will be explained in further detail below, the present application integrates one or more auxiliary windings within a motor to power one or more accessory devices (e.g., sensors, rectifiers, and/or external accessories electrically connected to a rectifier or other circuit elements). For example, auxiliary winding(s), rectifier(s), sensor(s) (e.g., sensor electronics package), and/or user-accessible power port(s) may be directly integrated into the motor (e.g., an electronic motor). In some instances, the power port may be located at a motor terminal box or an auxiliary box. As such, the auxiliary windings may be configured as a power supply to power the accessory devices (e.g., to power diagnostic features and/or other types of accessory devices). Therefore, in some examples, the motor might not include a separate power supply or battery to power these accessory devices.

In operation, the stator of the motor may be configured to act similar to a transformer by coupling the primary winding/coil voltage to the auxiliary winding/coil voltage using the magnetic flux of the stator. Based on the auxiliary winding (e.g., the auxiliary coil) being the same pitch as the primary winding (e.g., the primary coil), the induced energy (e.g., induced current or voltage) may be determined as the ratio of the number of turns of the primary winding to the number of turns of the secondary or auxiliary winding. Therefore, for harvesting power that is used for the auxiliary devices, the auxiliary windings may produce a sinusoidal alternating current (AC) voltage that may be connected to one or more accessory devices such as a standard rectifier and/or one or more sensors. In some instances, the coupling of the primary and auxiliary windings may be configured to act as an initial filter, smoothing the square wave input from a VFD. Additionally, and/or alternatively, the auxiliary windings may be configured to provide (e.g., generate or produce) single phase power, three-phase power, and/or other number of phases of power so as to limit the rectified direct current (DC) capacitance required. In some instances, the auxiliary windings may be configured to provide one to ten watts (W) of power regardless of motor size, which may be used to power external consumer devices. This will be described in further detail below.

Exemplary aspects of using auxiliary windings of a motor to power accessory devices, according to the present disclosure, are further elucidated below in connection with exemplary embodiments, as depicted in the figures. The exemplary embodiments illustrate some implementations of the present disclosure and are not intended to limit the scope of the present disclosure.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

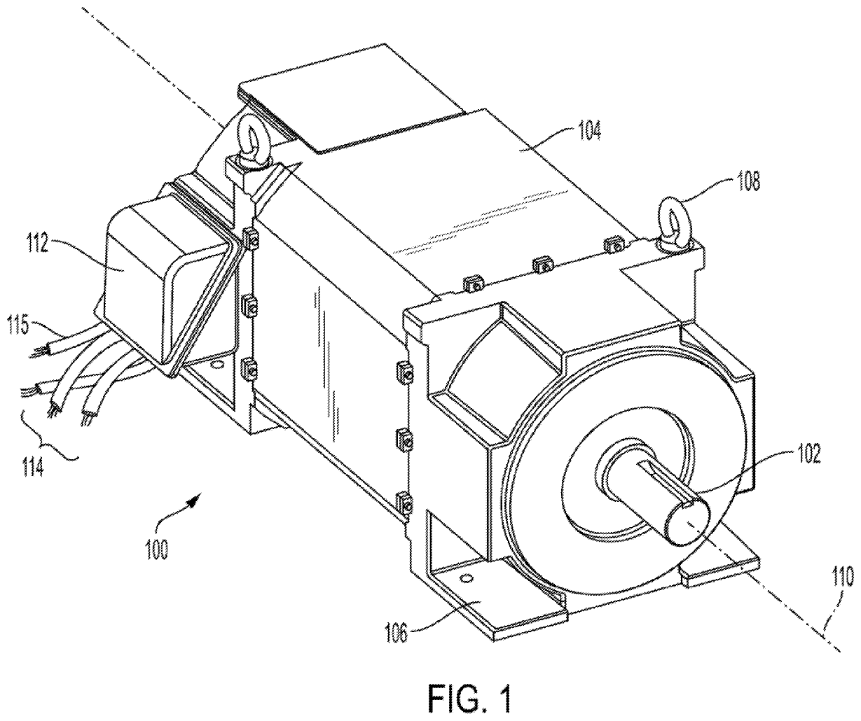

FIG. 1 is a perspective view of an electric motor delineating a rotational axis and configured for alternating current synchronous operation. For instance, FIG. 1 illustrates an example of a rotating electrical machine and particularly an electric motor 100 for converting electrical energy to a mechanical force in the form of torque that may be transmitted via a rotating motor shaft 102. The motor shaft 102 protrudes from the forward end of a motor enclosure 104 that encloses and houses the internal operating components of the electric motor 100. The motor enclosure 104 may be made from any suitable structural material such as cast iron, steel, aluminum or other suitable materials, and the enclosure may be configured according to common or standardized frame sizes that determine the location and arrangement of mounting features, such as mounting feet 106 and/or eyehooks 108. Further, the motor enclosure 104 may be designated in accordance with any of several enclosure types, such as open drip proof (ODP) or totally enclosed fan cooled (TEFC) that determine how the electric motor 100 is constructed to interact with the operating environment to provide for cooling and protect the internal components against contaminants like moisture and dust. For reference purposes, the motor shaft 102 is supported to rotate with respect to and defines a rotational axis 110 of the electric motor 100.

To receive electric current from an external power source, the electric motor 100 may include a conduit box or terminal box 112 located at an appropriate location on the motor enclosure 104 from which extends a plurality of power leads 114 such as insulated conductive wires. The power leads 114 may be electrically connected to and complete a circuit with the external power source that provides electricity of the appropriate electrical characteristics and properties for operation of the electric motor 100. For example, the electric motor 100 can be configured to operate on poly-phase, alternating current power source. In a poly-phase power system, the plurality of power leads 114 may each conduct alternating current electricity of the same frequency and voltage to the electric motor, but the alternating current conducted in each power lead may be out of phase with that in the other power leads. Accordingly, the cyclic oscillations between 0°-360° of alternating current in each power lead 114 may be delayed or advanced with respect to that in the other power leads. By way of example, a three-phase electric motor 100 may include three power leads 114 that conduct alternating currents that are 120° out of phase with each other and a fourth neutral or ground lead 115 that may be connected to an electrical ground, for example, the motor frame, and that serves as a reference.

In some instances, the three-phase electric motor 100 may include additional power leads such as power leads for connecting to and/or powering one or more external accessories (e.g., user-accessible power ports). For instance, the electric motor 100 may include primary and auxiliary windings (e.g., coils). The primary coils may act as a transformer and may be powered via the power leads 114. The primary coils may be coupled to the auxiliary windings such that when powered by the power leads 114, the primary windings causes induced voltage to be applied to the auxiliary windings. Accordingly, the auxiliary windings may be electrically connected to accessory devices such as the user-accessible power ports (e.g., additional power leads within the terminal box 112 that are configured to power user devices) and/or sensor devices.

In operation, to actuate rotation of the motor shaft 102, the motor 100 includes a rotor and a stator. The rotor is generally cylindrical in shape is assembled about the extension of the shaft 102 that is located within the enclosure 104 and is configured to electromagnetically interact with an annular stator in which the rotor is disposed. The cylindrical rotor and the annular stator are concentrically aligned with the rotational axis 110 of the electric motor 100 defined by the motor shaft 102.

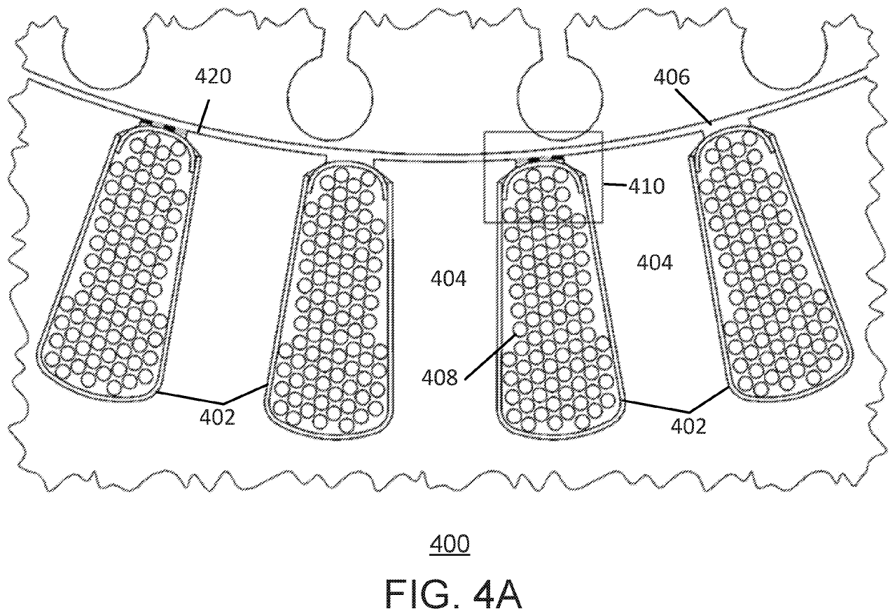

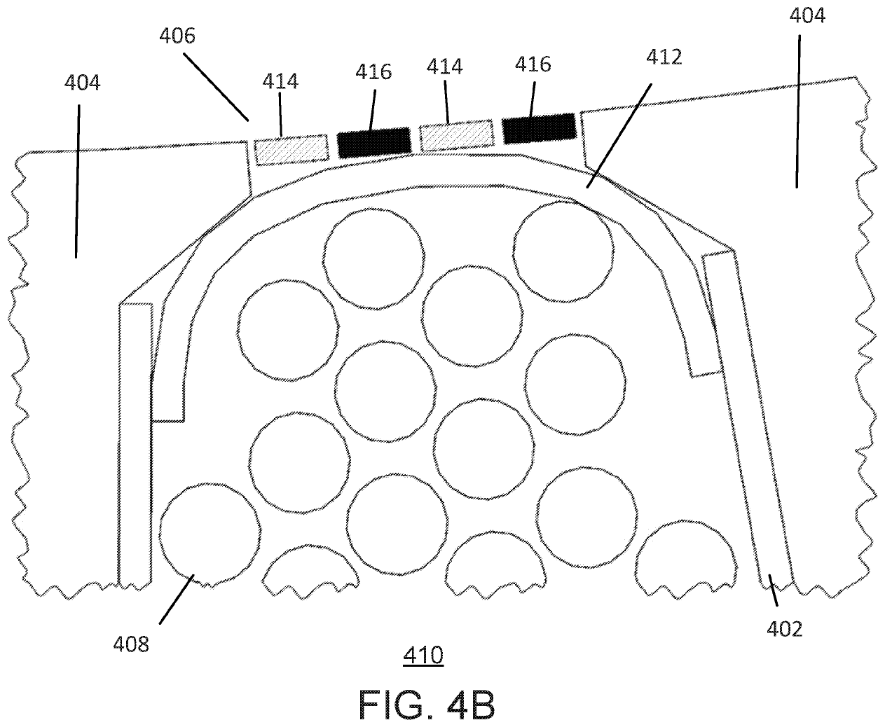

The annular stator may be fixedly disposed concentrically around the rotor and can be spaced apart and separated therefrom by an annular air gap (see FIGS. 4A and 4B below). The stator includes a stator core that may be made from a magnetically permeable material such as iron or steel. The stator core may be made from a plurality of annularly shaped core laminations that are axially arranged as a stack and extend coaxially along the rotational axis 110. The stator core may be fixed to and enclosed in the motor enclosure 104, which may include fins, water cooling jackets, and the like to promote cooling.

To accommodate the conductive windings (e.g., the primary windings or coils) that conduct current to generate the electromagnetic field, the stator core may include a plurality of stator teeth that are radially arranged in the circumferential direction around the rotational axis 110 and circumferentially separated from each other by stator slots radially disposed into the inner cylindrical surface of the stator core. Hence, between each two adjacent stator teeth, there is disposed a stator slot so that the teeth and slots circumferentially alternate about the inner cylindrical surface of the stator core. The alternating stator teeth and stator slots may axially extend along the axial length of the stator core with respect to the rotational axis 110.

The conductive windings (e.g., primary windings or coils) may be elongated wires of copper or other conductive material that are wound or looped about the stator teeth and accommodated in the stator slots. The conductive windings may be wound around a stator tooth or a plurality of stator teeth a number of successive times, each time being referred to as a “turn.” The total number of turns of the conducting winding about the same stator tooth or stator teeth forms a “coil.” For example, a coil may be formed from three, four, or five turns of the conductive winding. The conductive wires of the conductive winding may then be directed around additional stator teeth that are concentrically spaced from the initial coil in a continuous manner until the conductive windings circumscribe the inner circumference of the stator core. The path and geometry of the conductive windings around the stator core may be referred to as the “winding pattern,” and the winding pattern can take various arrangements and may determine the electrical characteristics and operating principles of the electric motor 100.

For example, the winding pattern may assign or allocate the coils by phases and by pole-phase groups 138. The phases may include the coils that are electrically connected in series to the same electrical phase of the poly-phase power source. For example, in a three-phase power system, for the electrical motor 100 to receive three-phase power, a first phase conductor may be associated with “A” phase current, a second phase conductor may be associated with “B” phase current, and a third phase conductor may be associated with “C” phase current. The phase conductors may be electrically connected with the power leads 114. The series of coils that are electrically connected to a respective one of the first, second, and third phase conductors is referred to as a phase. The number of coils included with each phase is dependent upon the number of stator teeth and stator slots. In the example of a large electrical motor 100 of the present disclosure, the stator core may include forty-eight stator teeth separated by forty-eight stator slots, such that each phase includes sixteen coils (48 coils÷3 phase=16 coils/phase).

The coils may also be associated with a plurality of pole-phase groups, referred to herein as phase groups, with each phase group providing a single electromagnetic pole of a single phase. A pair of phase groups associated with the north and south poles of a magnetic field can be located on diametrically opposite sides of the inner circumferential surface of the stator core. In the example of a three-phase, four pole electric motor 100 with forty-eight coils disposed about the stator, the electric motor 100 may include 12 phase groups 138 (48 coils÷(4 poles)=12 phase groups) with each phase group further including 4 coils.

In operation, when the first, second, and third phase conductors are energized from a three phase power system with alternating electric current that is 120° degrees out of phase by the respective conductor, the current flowing in the plurality of phases generates a magnetic field of changing polarity that circumferentially rotates around the rotational axis 110. As the polarity of one phase connected to the first conductor begins to change, e.g., from north to south, due to the periodic reversal of the direction of the alternating current associated with phase “A”, the polarity of the adjacent phase may become stronger because it is connected to the second or third phase conductor carrying current 120° degrees out of phase with the first conductor. The north and second magnetic poles of the permanent magnets disposed in the rotor are magnetically attracted to the opposite polarity associated with the magnetic field generated by the plurality the coils included with each of the phases and may follow that polarity as it moves from one phase to an adjacent phase. The rotor is thus caused to rotate with respect to the rotational axis 110.

However, while aspects of the disclosure may be described with respect to poly-phase alternating current power systems, aspects of the disclosure will also be applicable to other types of power systems and motor configurations.

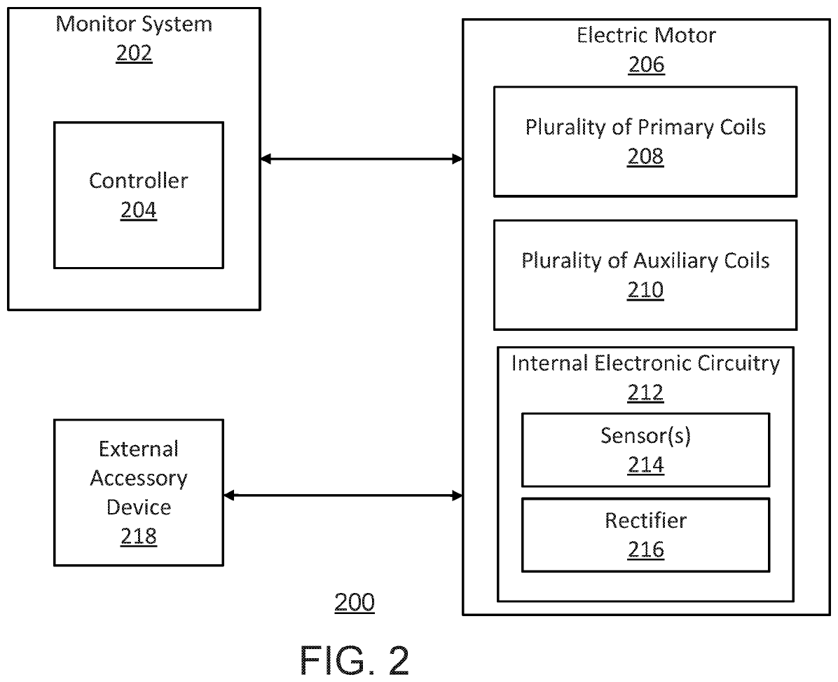

FIG. 2 is a schematic illustration of a block diagram depicting an environment for powering motor accessory devices using auxiliary windings of a motor in accordance with the disclosure. The environment 200 includes a control system 202, an electric motor 206, and an external accessory device 218. The electric motor 206 includes a plurality of primary coils (e.g., primary windings) 208, a plurality of auxiliary coils 210 (e.g., auxiliary windings), and internal electronic circuitry 212. The motor 206 may include an internal compartment that houses the internal electronic circuitry 212 such as sensors 214, the rectifier 216, and/or batteries/super capacitors. The internal electronic circuitry 212 includes sensors 214 (e.g., diagnostic sensors) and a rectifier 216.

The monitor system 202 includes one or more controllers 204. The controller 204 is in electrical communication with one or more components of the electric motor 206 and/or the external accessory device 218. The controller 204 is not constrained to any particular hardware, and the controller's configuration may be implemented by any kind of programming (e.g., embedded Linux) or hardware design-or a combination of both. For instance, the controller 204 may be formed by a single processor, such as general purpose processor with the corresponding software implementing the described control operations. On the other hand, the controller 204 may be implemented by a specialized hardware, such as an ASIC (Application-Specific Integrated Circuit), an FPGA (Field-Programmable Gate Array), a DSP (Digital Signal Processor), or the like. In some instances, the controller 204 may be implemented as software (e.g., one or more instructions stored in a non-transitory computer readable medium) rather than hardware elements.

In some examples, the monitor system 202 may be in a cloud environment (e.g., a cloud computing platform). Additionally, and/or alternatively, the monitor system 202 may be an industrial automation, industrial communication system, and/or a local edge device. In some examples, the monitor system 202 may control the motor 206 itself such as including a variable speed drive (VSD). For instance, the controller 204 may be the VSD. In some variations, the monitor system 202 may be a supervisory control and data acquisition (SCADA) system.

In some examples, the controller 204 may be in electrical communication with the electric motor 206 and provide instructions for operating the motor 206. For instance, the controller 204 may be configured to start, stop, and control the speed (e.g., rotations per minute (RPM)) of the motor 206.

Furthermore, the controller 204 may be in electrical communication with the sensors 214. For instance, the controller 204 may receive sensor information (e.g., frequency, speed, input current, temperature, output torque, diagnostic information, and/or other types of information) from the sensors 214. In some variations, the controller 204 may be operatively coupled to one or more external accessory devices 218. For instance, the external accessory devices 218 may be powered by the plurality of auxiliary coils 210 via rectifier 216.

The electric motor 206 may be the electric motor 100 that is described above in FIG. 1. For example, the electric motor 206 may be a three-phase electric motor. The motor 206 may include a rotor and a stator with a plurality of primary coils 208. Each of the primary coils 208 may be connected to one of the power leads 114, which are configured to provide AC power to the motor 206. As such, each of the primary coils 208 may be associated with a phase of the three-phases for the electric motor 206. As mentioned above, the primary coils 208 may be configured to generate a magnetic field based on power from an external power source via the power leads 114. The rotor of the motor may include magnets that are responsive to the generated magnetic field of the primary coils 208, thereby causing the motor shaft 102, which is attached to the rotor, to rotate. The motor shaft 102 may be operatively coupled to a load, and motor 206 may provide power to the load based on the rotation of the motor shaft 102.

Furthermore, the electric motor 206 includes a plurality of auxiliary coils 210. The current being provided to the primary coils 208 may be transferred as electrical energy to the auxiliary coils 210. For instance, the primary and auxiliary coils 208 and 210 may act as a transformer that is configured to transfer energy between the primary coils 208 to the auxiliary coils 210. For example, the primary coils 208 may produce a magnetic flux, which causes an induced voltage/current to be generated in the auxiliary coils 210. The amount of induced voltage/current in the auxiliary coils 210 may be based on the number of turns in the primary coils 208 as compared to the number of turns in the secondary or auxiliary coils 210.

In some instances, for harvesting power, the auxiliary coils 210 may produce a sinusoidal AC voltage that may be connected to a standard rectifier (e.g., the rectifier 216). The coupling to the stator current may act as an initial filter, smoothing the square wave input from a VFD. Additionally, and/or alternatively, the auxiliary coils 210 may be configured to produce a single phase, a three-phase, and/or any other number of phases of power.

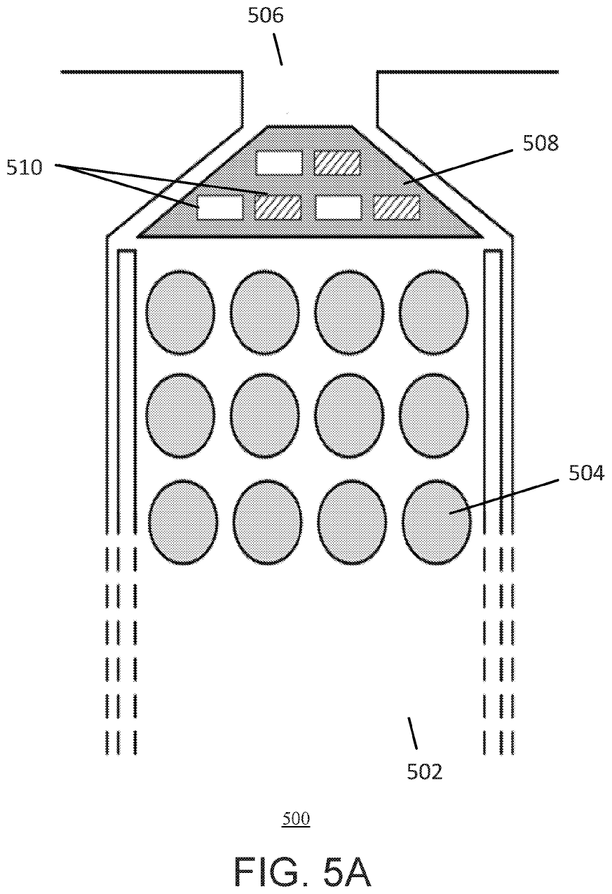

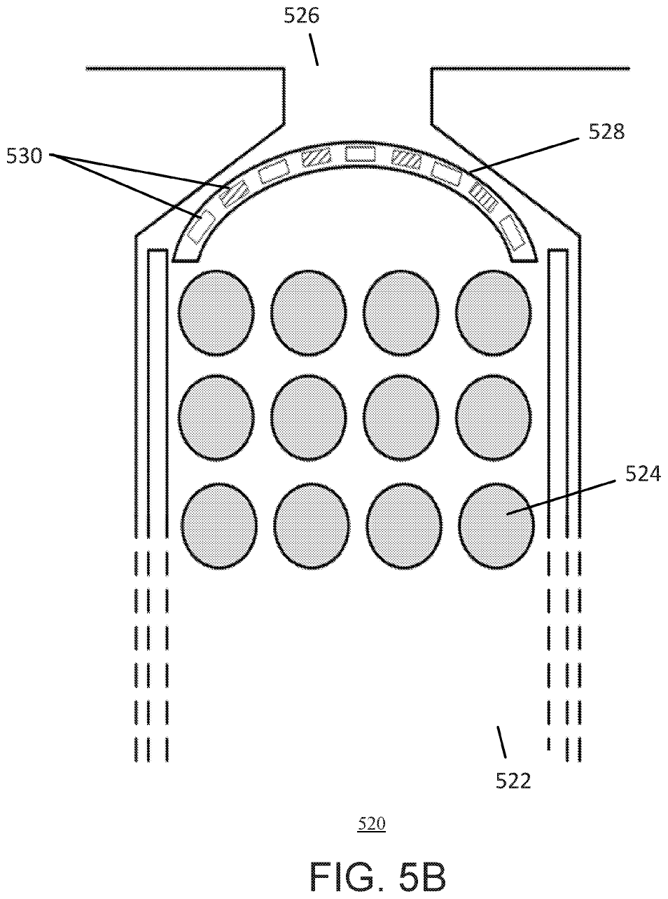

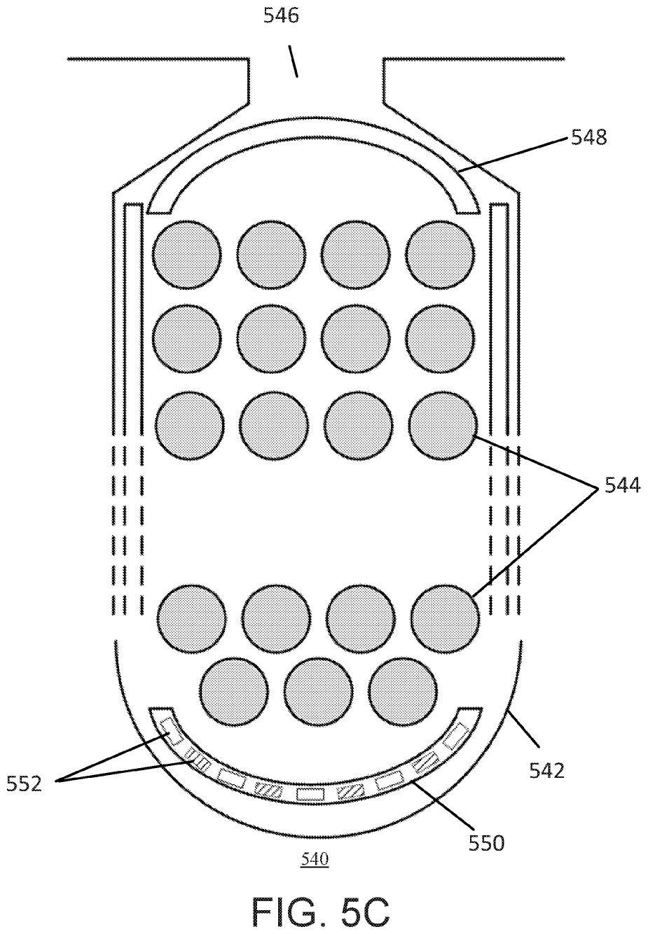

In some examples, the auxiliary coils 210 are coupled to, mounted on, and/or positioned on or within the stator (e.g., the stator of the motor 206). For instance, as shown in FIGS. 4A and 4B, the auxiliary coils 210 may be within the air gap 406 and mounted onto the stator core. Additionally, and/or alternatively, the auxiliary coils 210 may be within an insulating component of the stator (e.g., as shown in FIGS. 5A, 5B, and 5C).

In some examples, the internal electronic circuitry 212 may include one or more fail-safe components or elements that are configured to provide support to the motor 206 based on the auxiliary coils 210 fail to be grounded or be short-circuited on their output side (e.g., their output connections to the sensors 214 and/or the rectifier 216). For instance, the internal electronic circuitry 212 may include one or more printed circuit board (PCB) trace fuses, current-limiting resistors, and/or other types of circuitry for protecting the motor 206 and/or the accessory devices.

In some variations, the auxiliary coils 210 may be configured to provide up to or more than 10 W, regardless of motor size, and so can be used to power external customer devices (e.g., the external accessory device 218). For the external accessory devices 218, the motor 206 may include reinforced insulation for the primary coils 208, such as one or more insulating components (e.g., slot liners). For instance, based on the auxiliary coils 210 being in contact with the stator of the motor 206, this provides a clear path to ground in the event of an insulation failure.

Additionally, and/or alternatively, in view of user safety, the auxiliary coils 210 and/or the output of the rectifier 216 may be connected to the earth ground to limit the floating potential to which a user may be exposed to so as to keep the potential to be within safe limits. However, a low impedance ground connection in the auxiliary coils 210 and/or components connected to the auxiliary coils 210 (e.g., the sensors 214 and/or the rectifier 216) may introduce additional ground currents, including high frequency currents in the presence of a VFD, which may lead to tripping of the VFD or other ground protections in the distribution network. Accordingly, the internal electronic circuitry 212 may include one or more common mode filters or the use of an additional high frequency isolation through the DC-DC stage for the grounding scheme to limit these ground currents.

In some examples, for diagnostic purposes, the voltage of the auxiliary coils 210 may be proportional to the derivative of the enclosed motor flux. One or more sensors 214 may detect the voltage of the auxiliary coils 210 and/or other sensor measurements, and provide the voltage/other sensor measurements to the controller 204. Additionally, and/or alternatively, the voltage from the auxiliary coils 210 may be fed directly to the controller 204.

The external accessory device 218 may be in electrical communication with the motor 206 via the rectifier 216. Furthermore, the external accessory device 218 may be in electrical communication with the monitor system 202 and/or the controller 204. The external accessory device 218 may be a user device. The external accessory device 218 may be any type of user device such as, but not limited to, condition monitoring sensors (e.g., temperature and/or vibration sensors that provide status locally or remotely via wireless link), sensors on machinery that is coupled to the motor 206 (e.g., pump fluid flow, temperature and pressure, fan air flow, and/or conveyor belt speed sensors), and/or a motor bearing automated greaser.

For instance, the motor 206 may include one or more user-accessible power ports that a user may power using the power from the auxiliary coils 210. For example, the rectifier 216 may be configured to rectify the energy (e.g., the induced current) from the auxiliary coils 210 and provide the rectified energy to one or more user-accessible power ports. The external accessory device may be a user device that is connected to the one or more user-accessible power ports. As such, the auxiliary coils 210 may provide rectified energy to the external accessory device 216 via the rectifier 216.

The sensors 214 may be any type of sensors that are configured to detect sensor information and/or provide the sensor information to the controller 204. The sensors 214 may be electrically connected to the auxiliary coils 210 such that the auxiliary coils 210 provide energy (e.g., the induced current) to the sensors 214. The sensors 214 may be and/or include any type of sensors that are configured to detect sensor information associated with the motor 206 and/or the environment 200. For instance, the sensors 214 may be configured to measure the operational variables of the motor 206 such as the air gap flux waveform, frequency, speed, input current, stator temperature, faulty conditions, eccentricity, and output torque. Additionally, and/or alternatively, the sensors 214 may be configured to measure bearing performance, trends in motor characteristics, and/or rotor eccentricity, and provide these measurements to the controller 204.

It will be appreciated that the exemplary environment 200 depicted in FIG. 2 is merely an example, and that the principles discussed herein may also be applicable to other situations—for example, including other types of devices, systems, and network configurations and/or excluding devices, systems, and/or components within environment 200. For instance, the sensors 214 and/or the external accessory device 218/the rectifier 216 may be optional. For example, in some instances, the environment 200 does not include the rectifier 216 and/or the external accessory devices 218. Instead, the environment 200 includes one or more sensors 214 that are powered by the auxiliary coils 210. The sensors 214 may provide sensor information to the controller 204. In other instances, the environment 200 includes the rectifier 216 and/or the external accessory devices 218, but does not include the sensors 214. Additionally, and/or alternatively, the external accessory device 218 may be a device that is in direct communication with the controller 204.

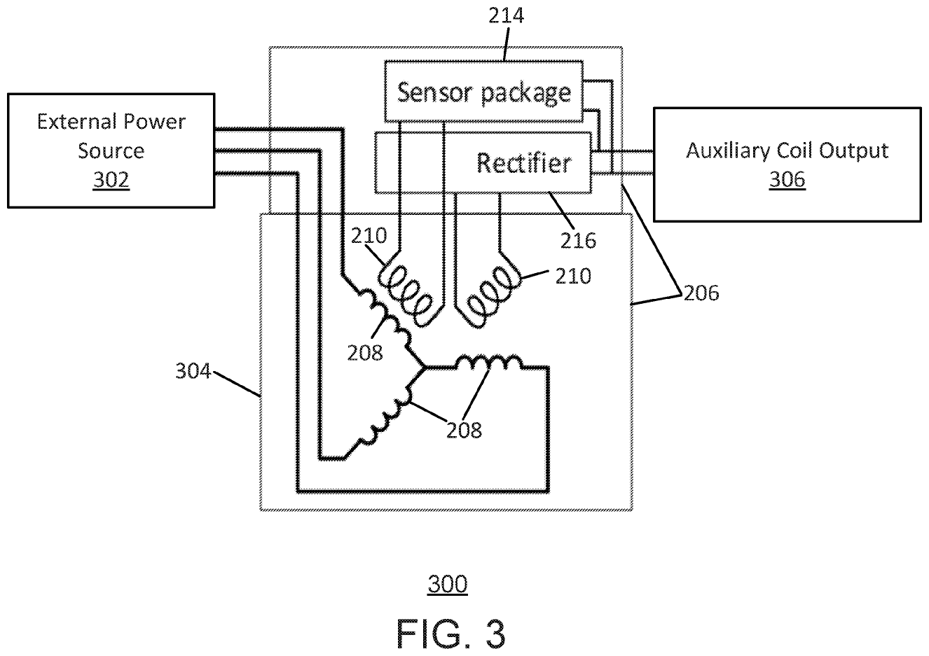

FIG. 3 is a schematic illustration depicting an exemplary environment for powering motor accessory devices using auxiliary windings in accordance with the disclosure. For example, the environment 300 shows the motor 206 of the environment 200. Furthermore, the motor 206 includes a stator 304 that includes the plurality of primary coils 208 and the plurality of auxiliary coils 210. The environment 300 includes an external power source 302, and the plurality of primary coils 208 are electrically connected to the external power source 302 (e.g., via the power leads 114). The external power source 302 may be any type of power source that is configured to provide electrical energy (e.g., voltage, current, and/or power) to the motor 206. In some instances, the external power source 302 may be a three phase power source configured to provide AC electrical energy to the motor 206. Each of the three coils 208 shown in FIG. 3 may be a single phase of the three phases that are provided by the external power source 302.

Furthermore, the primary coils 208 may transfer energy from the external power source 302 to the auxiliary coils 210. For example, as mentioned above, the primary coils 208 may generate a magnetic flux based on the current from the external power source 302. The generated magnetic flux may induce a current within the auxiliary coils 210. As shown, each of the two auxiliary coils 210 may provide energy (e.g., the induced current) to the sensor package 214 and the rectifier 216 respectively. The sensor package 214 and the rectifier 216 are connected to the auxiliary coil output 306. The auxiliary coil output 306 may be and/or include a controller (e.g., the controller 204) and/or other types of devices (e.g., the external accessory device 218).

The sensor package 214 and the rectifier 216 being shown as connected to separate auxiliary coils 210 is merely exemplary. In other instances, the sensor package 214 and the rectifier 216 may be connected to the same auxiliary coil 210.

The induced current/voltage of the auxiliary coils 210 may be determined as the ratio of the number of turns of the primary coil 208 to the number of turns of the auxiliary coil 210. As such, based on the required power level of the connected accessory device (e.g., the sensor package 214 and/or the external accessory device 218), the number of turns in the primary coil 208 and the number of turns in the auxiliary coil 210 may be determined. In other words, the number of turns in the primary coil 208 and the number of turns in the auxiliary coil 210 within the motor 206 may be based on the installed sensor package 214 and/or the amount of desired power output by a user-accessible power port.

Additionally, and/or alternatively, a subset of auxiliary coils 210 (e.g., two or more auxiliary coils 210) may be configured to provide power (e.g., induced current) to the sensor package 214 and/or the rectifier 216. For instance, each auxiliary coil 210 may be configured to provide a certain amount of power (e.g., 1 W) to the sensor package 214. The sensor package 214 may use an amount of power (e.g., 5 W) that is greater than the amount of power a single auxiliary coil 210 may be able to provide. As such, a subset of auxiliary coils 210 (e.g., five auxiliary coils 210) may be configured to provide power to the sensor package 214.

FIG. 4A is a schematic cross-section representation of an electric motor having a plurality of auxiliary coils and a plurality of stator slots for accommodating a plurality of primary coils in accordance with the disclosure. In particular, the cross-section representation 400 of the electric motor may be a cross-section representation of a part of the electric motor of FIGS. 1-3. For example, as mentioned above, a stator (e.g., stator 304) includes a plurality of stator slots 402 that are radically disposed about the stator core. Within each of the stator slots includes a plurality of primary coils or windings 408 (e.g., the primary coils 208 shown in FIG. 2). Further, in-between each of the stator slots are stator laminations 404. The laminations 404 are configured to reduce the eddy current by insulating the stator core. In some instances, the laminations 404 may be silicon steel plates. Also, the cross-section representation 400 shows the air gap 406. The air gap 406 is a gap of air between the stator and the rotor, and separates the rotor and stator core. The motor shown in the cross-section representation 400 further includes a plurality of auxiliary coils that are configured to provide induced current/voltage to the accessory devices (e.g., the sensors 214 and/or the external accessory device 218). This is shown in window 410, which is described in more detail in FIG. 4B.

In particular, FIG. 4B is a detailed view of one section of the electric motor of FIG. 4A (e.g., window 410 of FIG. 4A) and shows the primary coils and the auxiliary coils of the electric motor. For example, FIG. 4B shows the primary coils 408, a stator slot 402, and the lamination 404 between the stator slots 402. Furthermore, FIG. 4B shows the air gap 406 and a plurality of auxiliary coils 414 and 416 disposed within the air gap 406. The plurality of auxiliary coils 414 may be configured to provide power to one or more accessory devices such as the sensors 214. Additionally, and/or alternatively, the plurality of auxiliary coils 416 may be configured to power one or more additional accessory devices such as the external accessory device 218 via the rectifier 216. Between the primary coils 408 and the auxiliary coils 414, 416 is an insulating component 412 such as a slot liner. The insulating component 412 (e.g., the slot liner) may be a primary insulation component in a rotor and may be configured as an insulation barrier between the primary coils and the rotor core. Additionally, the insulating component 412 may be configured as an insulation barrier between the primary coils 408 and the auxiliary coils 414, 416.

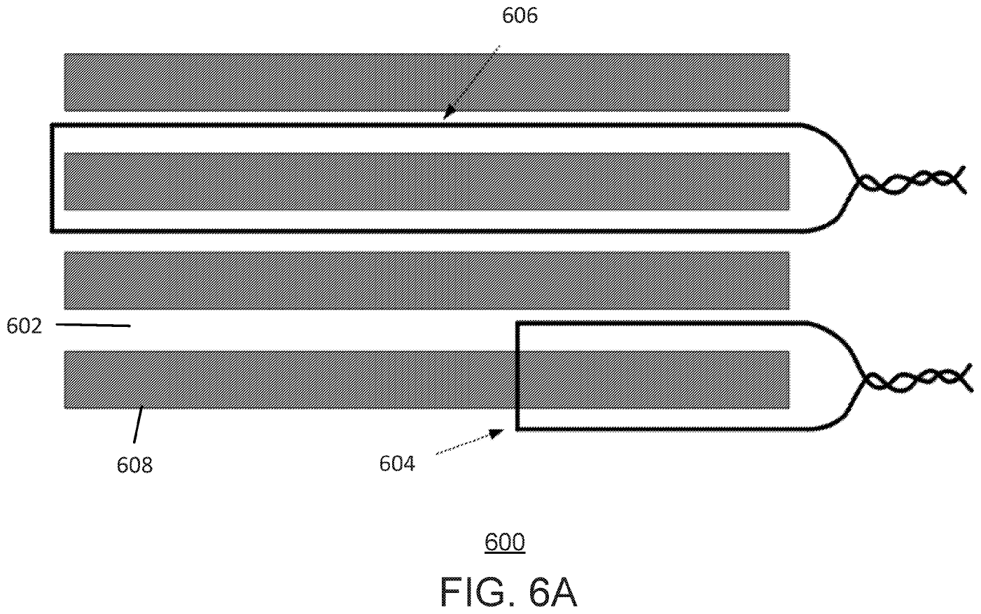

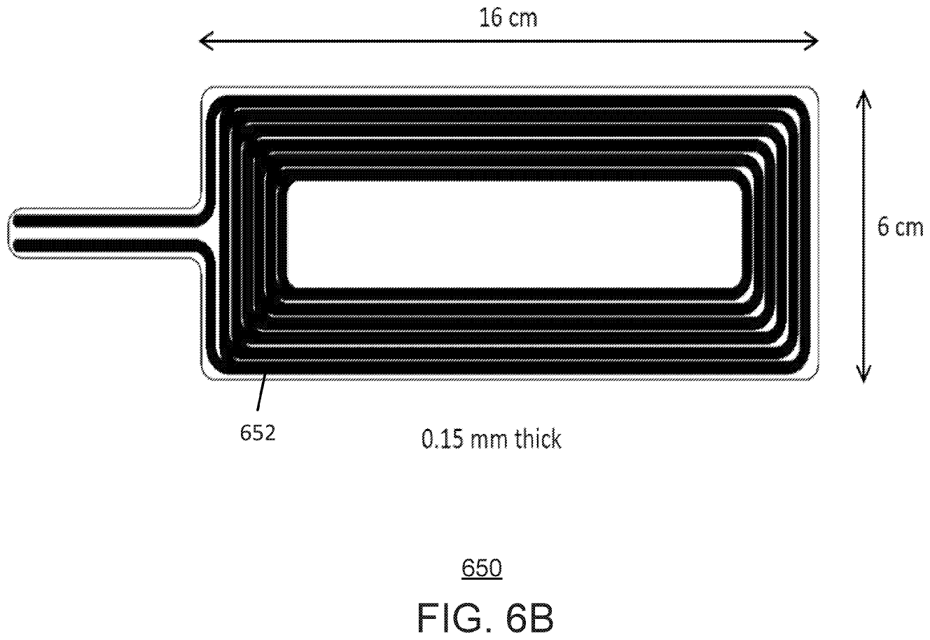

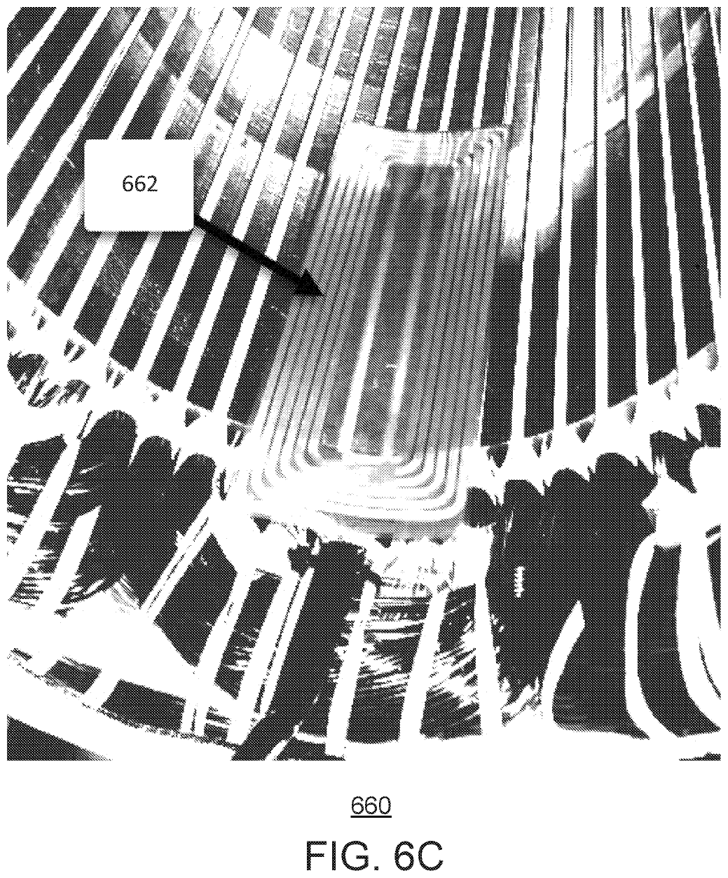

The configuration shown in FIGS. 4A and 4B of a motor with the auxiliary coils 414, 416 and the primary coils 408 separated by the insulating component 412 is merely exemplary, and other configurations are contemplated herein. For instance, in another embodiment, the auxiliary coils may be integrated into a printed circuit board (PCB) and disposed (e.g., attached) to the bottom of the air gap 406 (e.g., a side of the air gap located at and/or mounted on the internal diameter of the stator). For instance, referring to FIG. 4A, the PCB with the integrated auxiliary coils may be located at (e.g., coupled to) the bottom of the air gap 406, which is denoted by reference number 420. The PCB coil that is disposed to the bottom of the air gap is shown and described in FIG. 6B below. Furthermore, FIGS. 5A-5C show additional and/or alternative configurations of auxiliary coils, primary coils, and insulating components.

In particular, FIGS. 5A-5C are schematic cross-section representations 500, 520, 540 of an electric motor having a plurality of auxiliary coils, a plurality of primary coils, and one or more insulating components in accordance with the disclosure. For example, FIG. 5A shows an embodiment of an electric motor with a plurality of auxiliary coils, a plurality of primary coils, and an insulating component. The motor shown in FIG. 5A includes a stator slot 502. Within the stator slot 502 includes a plurality of primary coils 504. Further, an air gap 506 is shown. Between the air gap 506 and the primary coils 504 is an insulating component 508. A plurality of auxiliary coils 510 are included within the insulating component 508. For example, the insulating component 508 may be a slot wedge that is integrated with windings (e.g., the auxiliary coils 510). Additionally, the auxiliary coils 510 may be separated into two subsets—one for the sensors 214 and the other for the external accessory devices 218 via the rectifier 216. The two subsets of auxiliary coils 510 are denoted by the white boxes and the dashed boxes.

FIG. 5B shows another embodiment of an electric motor with a plurality of auxiliary coils, a plurality of primary coils, and an insulating component. The motor shown in FIG. 5B includes a stator slot 522. Within the stator slot 522 includes a plurality of primary coils 524. Further, an air gap 526 is shown. Between the air gap 526 and the primary coils 524 is an insulating component 528. A plurality of auxiliary coils 530 are included within the insulating component 528. For example, the insulating component 528 may be a slot liner and/or a flexible printed circuit board (PCB). The slot liner and/or PCB may be integrated with windings (e.g., the auxiliary coils 530). Additionally, the auxiliary coils 530 may be separated into two subsets-one for the sensors 214 and the other for the external accessory devices 218 via the rectifier 216. The two subsets of auxiliary coils 530 are denoted by the white boxes and the dashed boxes.

FIG. 5C shows an embodiment of an electric motor with a plurality of auxiliary coils, a plurality of primary coils, and two insulating components. The motor shown in FIG. 5C includes a stator slot 542. Within the stator slot 542 includes a plurality of primary coils 544. Further, an air gap 546 is shown. Between the air gap 546 and the primary coils 544 is an insulating component 548. The insulating component 548 is configured as an insulation barrier between the primary coils 544 and the rotor core. A second insulating component 550 is also shown. A plurality of auxiliary coils 552 are included within the insulating component 550. The insulating components 548 and/or 550 may be slot liners and/or flexible PCBs. Furthermore, the insulating component 550 is integrated with windings (e.g., the auxiliary coils 552). To put it another way, the motor of FIG. 5C includes two separate insulating components-one for the auxiliary coils 552 and another for insulation between the primary coils and the rotor core. Additionally, the auxiliary coils 552 may be separated into two subsets-one for the sensors 214 and the other for the external accessory devices 218 via the rectifier 216. The two subsets of auxiliary coils 552 are denoted by the white boxes and the dashed boxes.

FIG. 6A is a schematic illustration 600 depicting stator slots and poles of an electric motor with partial auxiliary windings and full length auxiliary windings in accordance with the disclosure. For instance, four stator poles 608 (e.g., stator teeth) are shown as well as three stator slots 602 between each of the poles 608. Further, for two of the stator poles 608, auxiliary windings 604 and 606 (e.g., the auxiliary coils) are shown to be wound with the stator poles 608. In particular, the auxiliary windings may travel to the whole length to complete the loop (e.g., the auxiliary winding 606) or may trace back with partial length (e.g., the auxiliary winding 604).

FIG. 6B is a schematic illustration 650 depicting an exemplary printed circuit board (PCB) air gap coil in accordance with the disclosure. For instance, as mentioned above, the auxiliary coils may be integrated into a printed circuit board (PCB) as coils 652 and disposed (e.g., attached) to the bottom of the air gap (e.g., the air gap 406). As shown, the coils 652 are. 15 millimeter (mm) thick with a width of 16 centimeters (cm) and height of 6 cm. Furthermore, the coils 652 may be a 12 turn patch coil with a resistance of 1.4 ohms, inductance (in free space) of 18 micro Henrys (μH), inductance (in air gap) of 250 μH, and root mean square (RMS) open circuit voltage at 50 hertz (Hz) of 8.8 Volts (V). The coils 652 is merely an example and other air gap coils with different dimensions and/or electrical characteristics may be used as the auxiliary coils. In some instances, the coils 652 may include a number of turns (N) and the averaged area (A) in square meters of the individual turns follow the inequality equation N*A>0.02.

FIG. 6C is a captured image of an electrical motor with an exemplary printed circuit board (PCB) air gap coil in accordance with the disclosure. In particular, FIG. 6C shows a captured image 660 with a printed PCB board with coils 662. For instance, image 660 shows the shared harvesting and measurement windings (e.g., auxiliary coils) 662 that are on a printed PCB board.

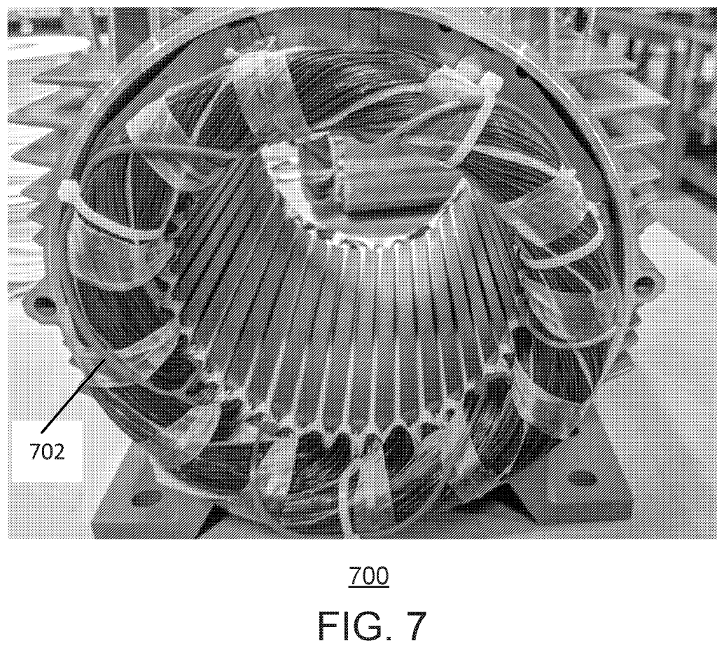

FIG. 7 is a captured image of an electrical motor with primary and auxiliary coils in accordance with the disclosure. In particular, FIG. 7 shows a captured image 700 with primary and auxiliary coils. For instance, image 700 shows the shared harvesting and measurement windings (e.g., auxiliary coils) 702 as a magnet wire that is co-located in the stator slots with the main winding.

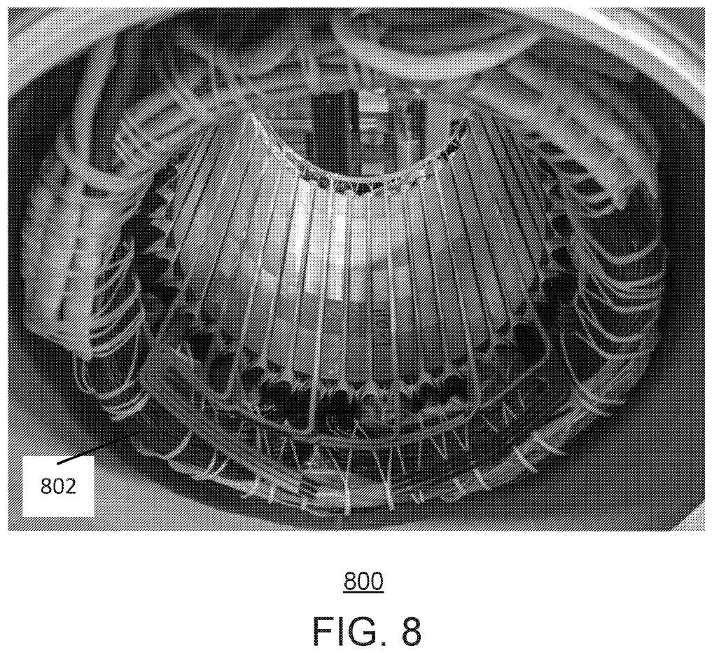

FIG. 8 is another captured image of an electrical motor with primary and auxiliary coils in accordance with the disclosure. In particular, FIG. 8 shows a captured image 800 with primary and auxiliary coils. For instance, image 800 shows the harvesting and measurement windings (e.g., the auxiliary coils) 802 as a flexible PCB located above the slot wedge against the air gap.

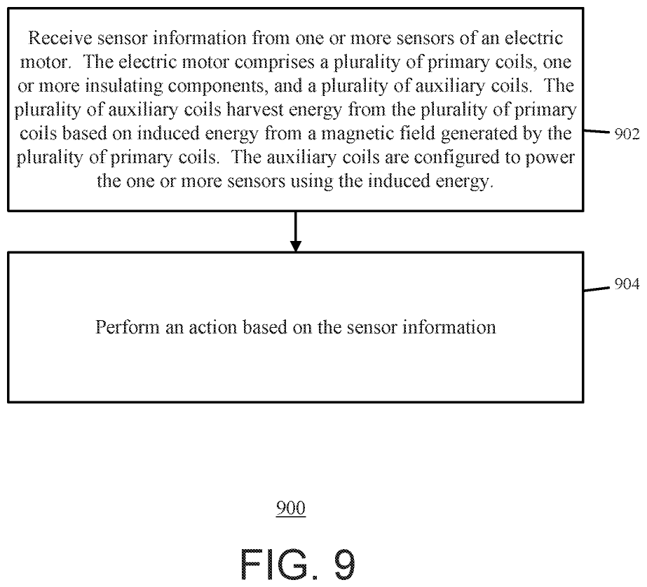

FIG. 9 depicts an exemplary process for powering motor accessory devices using auxiliary windings of a motor in accordance with the disclosure. The process 900 may be performed by the controller 204 shown in FIG. 2. However, it will be recognized that any of the following blocks may be performed in any suitable order and that the process 900 may be performed in any suitable environment and by any suitable controller or processor.

At block 902, the controller 204 receives sensor information from one or more sensors 214 of an electric motor 206. The electric motor 206 comprises a plurality of primary coils 208, one or more insulating components (e.g., a slot liner or slot wedge), and a plurality of auxiliary coils 210. The plurality of auxiliary coils 210 harvest energy from the plurality of primary coils 208 based on induced energy (e.g., induced current or voltage) from a magnetic field generated by the plurality of primary coils. The auxiliary coils 210 are configured to power the one or more sensors (and/or additional/alternative accessory devices such as the external accessory device 218) using the induced energy.

In other words, the plurality of primary coils generate a magnetic field based on receiving power from an external power source. The plurality of auxiliary coils harvests energy from the plurality of primary coils and provides the harvested energy to the one or more accessory devices. The harvested energy is an induced current or voltage caused by the generated magnetic field of the plurality of primary coils.

At block 904, the controller 204 performs an action based on the sensor information (e.g., display information associated with the sensor information).

In some instances, the primary coils 208 may generate a magnetic field based on power from an external power supply. The auxiliary coils 210 may harvest energy (e.g., induced current/voltage) based on the generated magnetic field from the primary coils 208. The auxiliary coils 210 may power one or more accessory devices using the harvested energy. For instance, the auxiliary coils 210 may power one or more sensors 214 that are configured to measure the operational variables of a motor.

In some examples, the sensors 214 may use energy harvested by the same auxiliary coil 208 or by different auxiliary coils 208 (e.g., a single auxiliary coil 208 may power the sensors or multiple auxiliary coils 208 may power the sensors).

In some variations, the auxiliary coils 210 may harvest energy that is used to power accessory devices such as external accessory devices 218. In some instances, the external accessory devices 218 may be coupled to the motor via a dedicated power port or receptacle.

In some examples, input voltage to the motor 206 may be either grid AC and/or a pulse train generated by a VFD. In other words, the motor 206 may receive power from an external power source that is providing three-phase AC power (e.g., grid AC) and/or may receive power as a pulse train generated by a VFD.

In some variations, the auxiliary coils 210 may provide single AC phase and/or any number of poly-phase current to the accessory devices (e.g., the sensors 214 and/or the external accessory devices 218).

In some instances, the auxiliary coils 210 may be located either in the stator slots with the main windings (e.g., the primary coils 208), as part of or against an insulating component (e.g., the slot wedge or slot liner), in an additional separate and dedicated slot or path anywhere in the stator lamination, between the slot wedge and air gap, and/or in the air gap itself.

In some examples, the auxiliary coils 210 may be implemented as a rigid or flexible printed circuit board.

In some instances, the auxiliary coils 210 may be integrated into the slot wedge or slot insulation liner.

In some variations, the auxiliary coils 210 may travel through the whole pole length to complete the loop or may trace back along a partial pole length.

In some examples, the power producing auxiliary winding and the winding for sensing purpose may collocate in same slots or may be placed in separated slots. To put it another way, in one or more examples, the auxiliary coils 210 that are used to power the sensors 214 and the external accessory devices 218 may be located in the same stator slot. In other examples, the auxiliary coils 210 that are used to power the sensors 214 and the external accessory devices 218 may be located in separate stator slots (e.g., one slot for the sensors 214 and another slot for the external accessory devices 218).

In some instances, the insulation around the auxiliary coils 210 may use enhanced insulation in between primary winding and/or stator lamination. For instance, the auxiliary coils may have an insulation coating, but in some examples, this coating may not be sufficient. Hence, in some instances, the auxiliary coils 210 may use and/or include enhanced insulation and/or additional insulation.

In some variations, the electronics for voltage level conversion for the sensors 214 and/or the external accessory devices 218 may be collocated in the same PCB as the auxiliary coils 210. For instance, a PCB may include the auxiliary coils 210 and/or one or more converters configured to convert the induced voltage from the auxiliary coils 210 to another voltage level.

In some examples, the voltage conversion stage may include a suitable grounding scheme (e.g., one or more common mode filters) to ensure user safety and/or include filters or isolation elements to limit the disturbances to the VFD or other protections in the distribution network due to an increase in ground currents coming from the employed grounding scheme of the motor 206.

In some instances, the power provided by the auxiliary coils 210 to the external accessory devices 218 may be universal serial bus (USB) or other low voltage standards compliant (e.g., 5 Volts). In some examples, the USB compliant port may power the external accessory devices 218 and/or other devices that are internal to the motor itself (e.g., an accessory device within the motor).

In some variations, the auxiliary coils 210 may be installed in the motor 206 at the time of manufacture, and the electronics package (e.g., the sensors 214 and/or the rectifier 216) may be included at a later time.

In some examples, the output port (e.g., the user-accessible power ports) may be located in the wire terminal box (e.g., terminal box 112) and/or in a separate auxiliary box.

In some instances, an additional sensor system (e.g., within the motor 206 and/or external to the motor 206) may be integrated with the sensors 214 and/or the controller 204 to monitor further diagnostic information for the stator and rotor of the motor 206.

Using the auxiliary coils 210 as an auxiliary power source may provide advantages such as, but not limited to, powering sensor arrangements (e.g., sensors 214) within the motor 206 and/or providing power via an auxiliary power port to external customer applications (e.g., the external accessory device 218) without the need for an additional power supply. Additionally, and/or alternatively, for many electric motor applications, the installation cost of a low-voltage power supply may be cost prohibitive. As such, including the auxiliary coils 210 may be beneficial as there is not a requirement for a separate installation cost for the power supply. Further, the auxiliary coils 210 may be inexpensive to manufacture and may be included in the motor 206 at the time of manufacturing the motor 206. Additionally, and/or alternatively, the electronics package (e.g., the internal electronic circuitry 212 including the sensors 214 and the rectifier 216) may be included at a later instance in time. In some instances, due to the power port (e.g., a power lead that is powered by the auxiliary coils 210) having a low voltage, the power port may be adapted such that it can be converted to any conventional or non-conventional voltage using an appropriate adapter. In some examples, the power port may be in the range of multiple Watts. In some variations, the power port may be configured to provide power during the lifetime of the motor 206 and might not affect the performance of the motor 206.

In some instances, the motor 206 may include one or more batteries (e.g., back-up batteries) and/or super capacitors. For instance, referring to FIG. 2, the internal electronic circuitry 212 may include one or more batteries and/or super capacitors that may be powered using the auxiliary coils 210. For instance, the auxiliary coils 210 may charge and/or re-charge the batteries/super capacitors.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. For example, the various embodiments of the kinematic, control, electrical, mounting, and user interface subsystems can be used interchangeably without departing from the scope of the invention. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A system, comprising:
a poly-phase electric motor, comprising:
a rotor including a motor shaft delineating a rotational axis;
a stator concentrically disposed about the rotor, the stator including a stator core and a plurality of stator slots disposed radially into an inner cylindrical stator surface of the stator core;
a plurality of primary coils formed from first conductive windings, wherein the plurality of primary coils are located within the plurality of stator slots;
an insulating component disposed between the plurality of primary coils and a plurality of auxiliary coils and configured to be an insulation barrier between the plurality of primary coils and a plurality of auxiliary coils;
the plurality of auxiliary coils formed from second conductive windings and coupled to the stator; and
one or more accessory devices electrically connected to the plurality of auxiliary coils,
wherein the plurality of primary coils generate a magnetic field based on receiving power from an external power source, wherein the plurality of auxiliary coils harvests energy from the plurality of primary coils and provides the harvested energy to the one or more accessory devices, and wherein the harvested energy comprises an induced current or voltage caused by the generated magnetic field of the plurality of primary coils.

2. The system of claim 1, wherein the poly-phase electric motor further comprises:
an air gap disposed between the rotor and the stator, and wherein the plurality of auxiliary coils are disposed within the air gap of the poly-phase electric motor.

3. The system of claim 2, wherein a first stator slot, of the plurality of stator slots, comprises:
a first subset of primary coils of the plurality of primary coils; and
the insulating component, wherein the insulating component is a slot liner and is configured to be the insulation barrier between the plurality of primary coils and the plurality of auxiliary coils within the air gap as well as be an insulation barrier between the rotor and the stator.

4. The system of claim 2, wherein the poly-phase electric motor further comprises:
a printed circuit board (PCB) comprising the plurality of auxiliary coils, wherein the PCB is coupled to a side of the air gap.

5. The system of claim 4, wherein the plurality of auxiliary coils comprise a number of the turns, and wherein an average area for each of the number of turns follows an inequality of: N*A>0.02, where Nis the number of turns and A is the average area in square meters for each of the number of turns.

6. The system of claim 1, wherein the one or more accessory devices comprise one or more sensors and a rectifier, wherein the one or more sensors are solely powered by the harvested energy from the plurality of auxiliary coils.

7. The system of claim 6, further comprising:
a controller configured to:
receive sensor information from the one or more sensors; and
display information associated with the sensor information.

8. The system of claim 6, wherein the poly-phase electric motor further comprises:
a wire terminal box, wherein the wire terminal box comprises:
a plurality of first leads configured to provide poly-phase power to the plurality of primary coils; and
a user-accessible power port configured to receive the harvested energy from the plurality of auxiliary coils,
wherein the system further comprises:
an external accessory device electrically connected to the user-accessible power port, wherein the external accessory device is powered solely using the harvested energy from the plurality of auxiliary coils.

9. The system of claim 1, wherein the poly-phase electric motor further comprises:
a wire terminal box comprising a plurality of first leads configured to provide poly-phase power to the plurality of primary coils; and
an auxiliary terminal box comprising a user-accessible power port configured to receive the harvested energy from the plurality of auxiliary coils,
wherein the system further comprises:
an external accessory device electrically connected to the user-accessible power port, wherein the external accessory device is powered solely using the harvested energy from the plurality of auxiliary coils.

10. The system of claim 9, wherein the user-accessible power port is a universal serial bus (USB).

11. The system of claim 10, wherein the USB is configured to five volts (V) of direct current (DC) to the external accessory device or an internal accessory device that is within the poly-phase electric motor.

12. The system of claim 9, wherein the user-accessible power port is configured to provide alternating current (AC) to the external accessory device.

13. The system of claim 1, wherein a first stator slot, of the plurality of stator slots, comprises:
a first subset of primary coils of the plurality of primary coils; and
the insulating component, wherein the insulating component is a slot wedge that comprises the plurality of auxiliary coils.

14. The system of claim 1, wherein a first stator slot, of the plurality of stator slots, comprises:
a first subset of primary coils of the plurality of primary coils; and
the insulating component, wherein the insulating component is a slot liner that comprises the plurality of auxiliary coils.

15. The system of claim 1, wherein a first stator slot, of the plurality of stator slots, comprises:
a first subset of primary coils of the plurality of primary coils; and
the insulating component, wherein the insulating component is a printed circuit board (PCB) that comprises the plurality of auxiliary coils.

16. The system of claim 1, wherein a first stator slot, of the plurality of stator slots, comprises:
a first subset of primary coils of the plurality of primary coils;
the insulating component disposed between the plurality of primary coils and the plurality of auxiliary coils; and
a second insulating component disposed between the rotor and the stator and configured to be an insulation barrier between the rotor and the stator.

17. The system of claim 1, wherein the poly-phase electric motor further comprises one or more batteries and/or one or more super capacitors.

18. The system of claim 17, wherein the poly-phase electric motor further comprises an internal compartment that houses the one or more accessory devices as well as the one or more batteries and/or the one or more super capacitors.

19. The system of claim 17, wherein the plurality of auxiliary coils are configured to charge and/or re-charge the one or more batteries and/or the one or more super capacitors.

20. A poly-phase electric motor, comprising:
a rotor including a motor shaft delineating a rotational axis;
a stator concentrically disposed about the rotor, the stator including a stator core and a plurality of stator slots disposed radially into an inner cylindrical stator surface of the stator core;
a plurality of primary coils formed from first conductive windings, wherein the plurality of primary coils are located within the plurality of stator slots;
an insulating component disposed between the plurality of primary coils and a plurality of auxiliary coils and configured to be an insulation barrier between the plurality of primary coils and a plurality of auxiliary coils;
the plurality of auxiliary coils formed from second conductive windings and coupled to the stator; and
one or more accessory devices electrically connected to the plurality of auxiliary coils,
wherein the plurality of primary coils generate a magnetic field based on receiving power from an external power source, wherein the plurality of auxiliary coils harvests energy from the plurality of primary coils and provides the harvested energy to the one or more accessory devices, and wherein the harvested energy comprises an induced current or voltage caused by the generated magnetic field of the plurality of primary coils.
